(19) United States
(12) Patent Application Publication
(10) Pub. No.: US 2018/0167835 A1
(43) Pub. Date: Jun. 14, 2018

(54) Mobile Terminal

(71) Applicant: SHARP KABUSHIKI KAISHA, Sakai City, Osaka (JP)

(72) Inventors: YUHSUKE TAKAGI, Sakai City (JP); SHUICHI TAKEHANA, Sakai City (JP); SHUMPEI FUSE, Sakai City (JP); SHIGETO SUZUKI, Sakai City (JP); TOSHIAKI KAMENO, Sakai City (JP); TSUGUHIRO AOKI, Sakai City (JP); FUMIYO SATOH, Sakai City (JP)

(21) Appl. No.: 15/576,489

(22) PCT Filed: Apr. 21, 2016
(86) PCT No.: PCT/JP2016/062592

§ 371 Date: Nov. 22, 2017

(30) Foreign Application Priority Data
May 27, 2015 (JP) 2015-107273

(51) Int. Cl. H04W 24/10; H04W 92/18; H04W 88/06; H04W 88/04

(52) U.S. Cl. CPC H04W 24/10; H04W 92/18; H04W 88/023; H04W 88/04; H04W 88/06

(57) ABSTRACT

A UE, which is a mobile terminal, is capable of a device-to-device communication. The UE displays, on a display unit, an LTE antenna picto based on a reception level of a radio wave transmitted by a base station, and a D2D antenna picto based on a reception level of a radio wave transmitted by a UE over the device-to-device communication. According to the UE, the reception level of the radio wave in the device-to-device communication can be immediately confirmed, as well as a reception level of a radio wave in communication with the base station.

### BACKGROUND ART

The present invention relates to a mobile terminal communicable with a base station.

### BACKGROUND ART

Conventionally, various communication terminals, such as smartphones, each display on a display of the communication terminal a pictogram (hereinafter, also referred to as an “antenna picto”) which visually represents the reception level of a radio wave received by an antenna.

For example, Japanese Patent Laying-Open No. 2006-332942 (PTD 1) discloses a vehicle-mounted information terminal as a communication terminal that is capable of displaying the antenna picto. The vehicle-mounted information terminal is connectable to a base station via a mobile phone. The vehicle-mounted information terminal obtains sensitivity of communications between the mobile phone and the base station from the mobile phone. Moreover, the vehicle-mounted information terminal senses sensitivity of radio wave communications between the vehicle-mounted information terminal and the mobile phone. Further, the vehicle-mounted information terminal generates an icon corresponding to the sensitivity of communications between the mobile phone and the base station and selects a display color corresponding to the sensitivity of the radio wave communications between the vehicle-mounted information terminal and the mobile phone, thereby displaying the two types of communication sensitivity using the icon and the display color in a common area.

Moreover, conventionally, device-to-device (D2D) communication is known over which terminals (terminal: User Equipment) communicate with each other without via a base station (eNB: evolved NodeB). The device-to-device communication is also referred to as D2D Proximity Services (ProSe). Proximity Services are standardized according to 3rd generation partnership project (3GPP) Release 12.

### CITATION LIST

### Patent Document

PTD 1: Japanese Patent Laying-Open No. 2006-332942

### SUMMARY OF INVENTION

### Technical Problem

However, a user of a mobile terminal that is capable of the above device-to-device communication is, although able to immediately confirm by an antenna picto the reception level of a radio wave in communications with the base station, unable to immediately confirm the reception level of the radio wave in the device-to-device communication. Note that the vehicle-mounted information terminal disclosed in PTD 1 is not configured to directly communicate with the base station.

The present invention is made in view of the above problem and a disclosure of the present invention is to provide a mobile terminal which allows a user to immediately confirm the reception level of a radio wave in the device-to-device communication, as well as the reception level of the radio wave in communications with the base station.

### Solution to Problem

According to a certain aspect of the present invention, the mobile terminal is capable of a device-to-device communication. The mobile terminal includes a controller and a display unit. The controller causes the display unit to display a first antenna pictogram based on a reception level of a radio wave transmitted by a base station, and a second antenna pictogram based on a reception level of a radio wave transmitted by a first third-party terminal over the device-to-device communication.

### Advantageous Effects of Invention

According to the present invention, a user of the mobile terminal is allowed to immediately confirm the reception level of the radio wave in the device-to-device communication, as well as the reception level of the radio wave in the communication with the base station.

### BRIEF DESCRIPTION OF DRAWINGS

FIG. 1 is a diagram for illustrating a first aspect in a communication system 10.

FIG. 2 shows diagrams for illustrating antenna pictos on a UE 1 and a UE 2 in the conditions of FIG. 1.

FIG. 3 is a diagram for illustrating antenna pictos displayed on UE 1 in the first aspect illustrated in FIG. 1.

FIG. 4 shows diagrams for illustrating the antenna pictos on UE 1.

FIG. 5 is a diagram for illustrating a second aspect in the communication system 10.

FIG. 6 is a diagram for illustrating antenna pictos on UE 1 in the conditions of FIG. 5.

FIG. 7 is a diagram for illustrating a third aspect in the communication system 10.

FIG. 8 is a diagram for illustrating antenna pictos on UE 1 in the conditions of FIG. 7.

FIG. 9 is a diagram representing a situation where UE 1, which is an owner UE, has hidden an antenna picto for a relay in a certain aspect.

FIG. 10 is a diagram for illustrating a functional configuration of UE 1.

FIG. 11 is a flowchart for illustrating a flow of operation by UE 1.

### DESCRIPTION OF EMBODIMENTS

Hereinafter, a communication system according to embodiments of the present invention is described, with reference to the accompanying drawings. In particular, in the following, a mobile terminal (hereinafter, referred to as a “UE”), which is included in the communication system, is described. In the following description, the same reference sign is given to refer to the same component. The same applies to the name and functionality of the same component. Thus, detailed descriptions thereof are not repeated.

Examples of the UE include various communication terminals such as smartphones, tablets, phablets, etc. However, the UE is not limited thereto insofar as it is capable of communications with a base station (hereinafter, referred to as an “eNB”) and device-to-device communications (hereinafter, referred to as “D2D communication”).

In the following, initially, an antenna picto displayed by the UE in each situation is described, with reference to three aspects by way of example. Note that the term “picto” represents a “pictogram.”

<A. First Aspect>

FIG. 1 is a diagram for illustrating a first aspect in a communication system 10. Referring to FIG. 1, in the first aspect, communication system 10 includes an eNB 9 which is a base station, a UE 1 which is a mobile station within the communication coverage of eNB 9, and a UE 2 which is a third-party terminal with which UE 1 performs D2D communication.

UE 1 and UE 2 are terminals capable of the D2D communication. UE 1 is within a cell 900 served by eNB 9 (i.e., UE 1 is in In-coverage state). Therefore, UE 1 is able to perform long term evolution (LTE) communications with eNB 9. On the other hand, UE 2 is out of cell 900 (i.e., UE 2 is in Out-of-coverage state). Therefore, UE 2 is unable to perform LTE communications with eNB 9. Moreover, UE 1 and UE 2 have initiated the D2D communications with each other. As will be described below, UE 1 and UE 2 each display antenna pictos on a display unit 300.

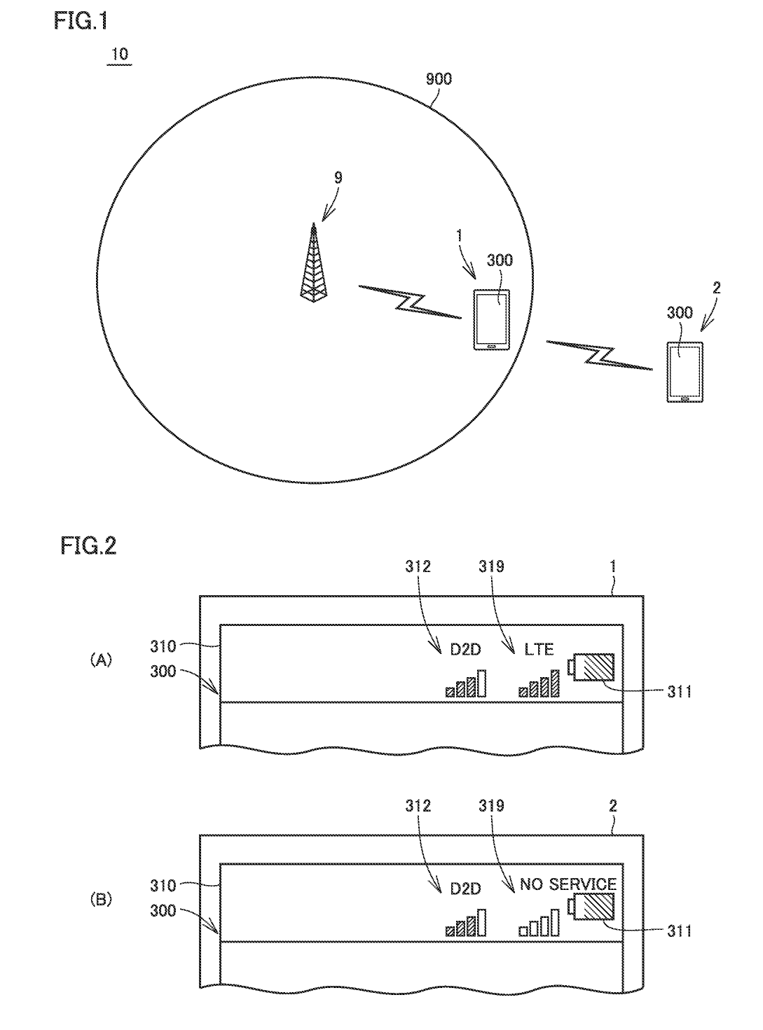

FIG. 2 shows diagrams for illustrating the antenna pictos on UE 1 and UE 2 in the conditions of FIG. 1. Part (A) of FIG. 2 is a diagram for illustrating the antenna pictos displayed on UE 1. Part (B) of FIG. 2 is a diagram for illustrating the antenna pictos displayed on UE 2.

Referring to (A) of FIG. 2, UE 1 displays, on display unit 300, a battery picto 311 representing a battery level, a first antenna picto 319 (hereinafter, also referred to as an “LTE antenna picto 319”) based on the reception level (i.e., radio strength) of a radio wave transmitted by eNB 9, a second antenna picto 312 (hereinafter, also referred to as a “D2D antenna picto 312”) based on the reception level of a radio wave transmitted by the third-party terminal (UE 2 in this case) over the D2D communications. Specifically, UE 1 displays battery picto 311, D2D antenna picto 312, and LTE antenna picto 319 on a status bar 310 displayed on display unit 300.

UE 1 is within cell 900 served by eNB 9, as mentioned above. Therefore, LTE antenna picto 319 is in a display aspect which indicates that UE 1 is able to receive radio waves from eNB 9. Moreover, UE 1 is in D2D communication with UE 2. Therefore, D2D antenna picto 312 is in a display aspect which indicates that UE 1 is able to receive radio waves from the third-party terminal with which UE 1 performs the D2D communication.

LTE antenna picto 319 includes identification information for clarifying that this picto is for the LTE communications. Typically, UE 1 displays a string “LTE” near antenna bars. D2D antenna picto 312 includes identification information for clarifying that this picto is for the D2D communications. Typically, UE 1 displays a string “D2D” near antenna bars.

Referring to (B) of FIG. 2, UE 2 displays battery picto 311, LTE antenna picto 319, and D2D antenna picto 312 on display unit 300. Specifically, UE 2, as with UE 1, displays battery picto 311, D2D antenna picto 312, and LTE antenna picto 319 on status bar 310.

UE 2 is out of cell 900 served by eNB 9, as mentioned above. Therefore, LTE antenna picto 319 is in a display aspect which indicates that UE 2 is unable to receive radio waves from eNB 9 (out-of-coverage state). As one example, UE 2 displays four white bars in LTE antenna picto 319 (i.e., displays four outlined bars).

UE 2 is in D2D communication with UE 1. Therefore, D2D antenna picto 312 is, as with UE 1, in a display aspect which indicates that UE 2 is able to receive radio waves from the third-party terminal with which UE2 performs the D2D communications.

As described above, UE 1 and UE 2 each can display LTE antenna picto 319 and D2D antenna picto 312 on display unit 300. Thus, users of UE 1 and UE 2 are able to immediately confirm the reception level of a radio wave in the D2D communications, as well as the reception level of a radio wave in the communications with eNB 9.

Note that in the following, an UE, which is within a cell served by eNB 9 and in D2D communication with another UE that is out of the cell served by eNB 9, is also referred to as an “owner UE.” For example, in FIG. 1, UE 1 corresponds to the owner UE. UE 2 corresponds to a first third-party terminal which is the third party with which UE 1 performs the D2D communications.

(First Variation)

In the following, First Variation of the first aspect with respect to the display of the D2D antenna picto is described.

According to the standard for the D2D communications, two operating modes are defined as operations of performing the D2D communications. “Mode 1,” which is a first operating mode, is an operating mode in which an UE communicates with a third-party UE, using a radio resource assigned by an eNB. “Mode 2,” which is a second operating mode, is an operating mode in which the owner UE communicates with a third-party UE, using a radio resource assigned by the owner UE itself. Specifically, in Mode 2, the owner UE assigns a radio resource within a predetermined radio resource pool for the D2D communication between the owner UE and the third-party UE.

The owner UE operates in Mode 1 when the third-party UE with which the owner UE communicates is within a cell where the owner UE is. In this case, the third-party UE, with which the owner UE communicates, operates in Mode 1, too. On the other hand, the owner UE operates in Mode 2 when the third-party UE with which the owner UE communicates is out of a cell where the owner UE is. In this case, the third-party UE with which the owner UE communicates operates in Mode 2, too.

For example, in the first aspect illustrated in FIG. 1, the owner UE is UE 1. UE 2, which is the third-party with which the owner UE communicates, is out of cell 900 where UE 1 is. Thus, UE 1 and UE 2 operate in Mode 2. If UE 2 is within cell 900 where UE 1 is, UE 1 and UE 2 operate in Mode 1.

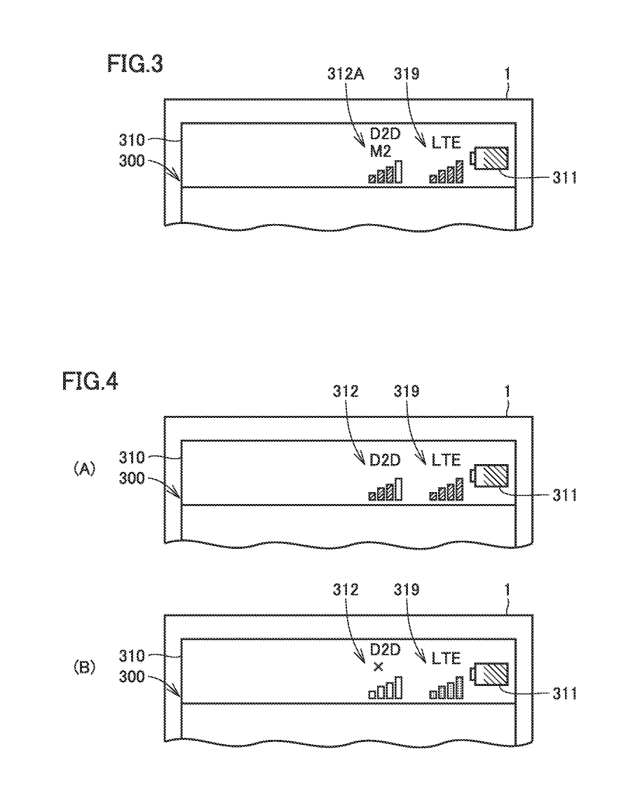

FIG. 3 is a diagram for illustrating antenna pictos displayed on UE 1 in the first aspect illustrated in FIG. 1. Referring to FIG. 3, UE 1 displays battery picto 311, LTE antenna picto 319, and a D2D antenna picto 312A on display unit 300. Specifically, UE 1 displays D2D antenna picto 312A on status bar 310, instead of D2D antenna picto 312 (see (A) of FIG. 2).

UE 1 is operating in Mode 2. For this reason, UE 1 displays information representing that UE 1 is operating in Mode 2 in D2D antenna picto 312A. In other words, D2D antenna picto 312A includes the information representing that UE 1 is operating in Mode 2. Typically, UE 1 displays an abbreviation of Mode 2 (“M2” in FIG. 3) near antenna bars. In this case, the user of UE 1 is allowed to confirm that UE 1 is operating in Mode 2 by status bar 310, thereby knowing that UE 2 is out of cell 900 where UE 1 is. In other words, the user of UE 1 is allowed to know that UE 2 is in “Out-of-coverage” state.

Note that, if UE 1 is operating in Mode 1, UE 1 displays information representing that UE 1 is operating in Mode 1 in D2D antenna picto 312A. Typically, UE 1 displays an abbreviation of Mode 1 (“M1” in FIG. 3) near the antenna bars. In this case, the user of UE 1 is allowed to confirm that UE 1 is operating in Mode 1 by status bar 310, thereby knowing that UE 2 is within cell 900 where UE 1 is. In other words, the user of UE 1 is allowed to know that UE 2 is in “In-coverage” state.

As described above, when UE 2 is within cell 900 served by eNB 9, UE 1 operates in Mode 1 as the operating mode in which UE 1 performs the D2D communications, wherein, in Mode 1, UE 1 uses the radio resource assigned by eNB 9 to communicate with UE 2. When UE 2 is out of cell 900 served by eNB 9, UE 1 operates in Mode 2 as the above operating mode, wherein, in Mode 2, UE 1 uses the radio resource assigned by UE 1 to communicate with UE 2. UE 1 displays the information representing that the above operating mode is either one of Mode 1 and Mode 2 on display unit 300. According to such a configuration, the user of UE 1 is allowed to know whether UE 2, which is the third-party terminal with which UE 1 performs the D2D communications, is within cell 900 where UE 1 is.

(Second Variation)

In the above, the first aspect has been described with reference to eNB 9, illustrated in FIG. 1, supporting the D2D communications. In other words, the first aspect has been described with reference to eNB 9 having capabilities to assign a radio resource for the D2D communications to a UE that is within a cell served by eNB 9.

In the following, antenna pictos are described which are displayed on UE 1 when an eNB, serving a cell where UE 1 is, has the above capabilities and when the eNB does not have the capabilities. In other words, antenna pictos are described which are displayed on UE 1 when the eNB supports and does not support the D2D communications. Note that UE 1 determines whether the eNB supports the D2D communications, based on cell information included in broadcast information sent from the eNB. In the following, as an example, suppose that UE 1 is within a cell served by the eNB and UE 1 is the owner UE.

FIG. 4 shows diagrams for illustrating antenna pictos on UE 1. Part (A) of FIG. 4 is a diagram for illustrating antenna pictos that are displayed on UE 1 when the eNB supports the D2D communications. Part (B) of FIG. 4 is a diagram for illustrating antenna pictos that are displayed on UE 1 when the eNB does not support the D2D communications.

Referring to (A) of FIG. 4, UE 1 displays battery picto 311, LTE antenna picto 319, and D2D antenna picto 312 on status bar 310, as with (A) of FIG. 2.

At this time, UE 1 displays all or some of antenna bars in LTE antenna picto 319 (all four antenna bars in (A) of FIG. 4) in a predetermined first color (e.g., blue) to represent the reception level in the LTE communications. Moreover, UE 1 displays all or some of antenna bars in D2D antenna picto 312 (three among the four antenna bars in (A) of FIG. 4) in the predetermined first color (e.g., blue) to represent the reception level in the D2D communications. Note that UE 1 displays the remaining one bar in white, among the four bars.

Referring to (B) of FIG. 4, UE 1 displays battery picto 311, LTE antenna picto 319, and D2D antenna picto 312 on status bar 310.

At this time, UE 1 displays all or some of antenna bars in LTE antenna picto 319 (all four antenna bars in (A) of FIG. 4) in a predetermined second color (e.g., red) different from the first color to concurrently represent the reception level in the LTE communications and that eNB 9 does not support the D2D communications.

When eNB 9 does not support the D2D communications, UE 1 cannot initiate D2D communications with UE 2. For this reason, UE 1 displays all antenna bars in D2D antenna picto 312 (four antenna bars in (A) of FIG. 4) in white to represent that UE 1 is unable to perform D2D communications. Further, UE 1 displays on D2D antenna picto 312 a sign (typically, a cross mark) representing that the D2D communications is not allowed.

When LTE antenna picto 319 is red (specifically, one or more of the antenna bars are red), the user of UE 1, which is the owner UE, is allowed to determine that UE 1 cannot initiate D2D communications by confirming red LTE antenna picto 319.

Note that D2D antenna picto 312 may be hidden in (B) of FIG. 4. Even in this case, the user of UE 1 is allowed to determine that UE 1 cannot initiate D2D communications by confirming red LTE antenna picto 319.

In the following, for purposes of explanation, the present disclosure is described with reference to the first color being “blue” and the second color being “red.”

<B. Second Aspect>

FIG. 5 is a diagram for illustrating a second aspect in the communication system 10. Referring to FIG. 5, in the second aspect, communication system 10 includes eNB 9, UE 1, UE 2, and a UE 3.

UE 1 is within cell 900 served by eNB 9. On the other hand, UE 2 and UE 3 are out of cell 900. D2D communications have been established between UE 1 and UE 2. D2D communications have been established also between UE 2 and UE 3. Specifically, UE 1 is communicable with UE 3 via UE 2. In other words, UE 1 uses UE 2 as a “relay” for the communications with UE 3.

Here, UE 1 corresponds to the owner UE. UE 2 corresponds to the first third-party terminal with which UE 1 performs the D2D communications, and UE 3 corresponds to a second third-party terminal with which UE 2 performs the D2D communications.

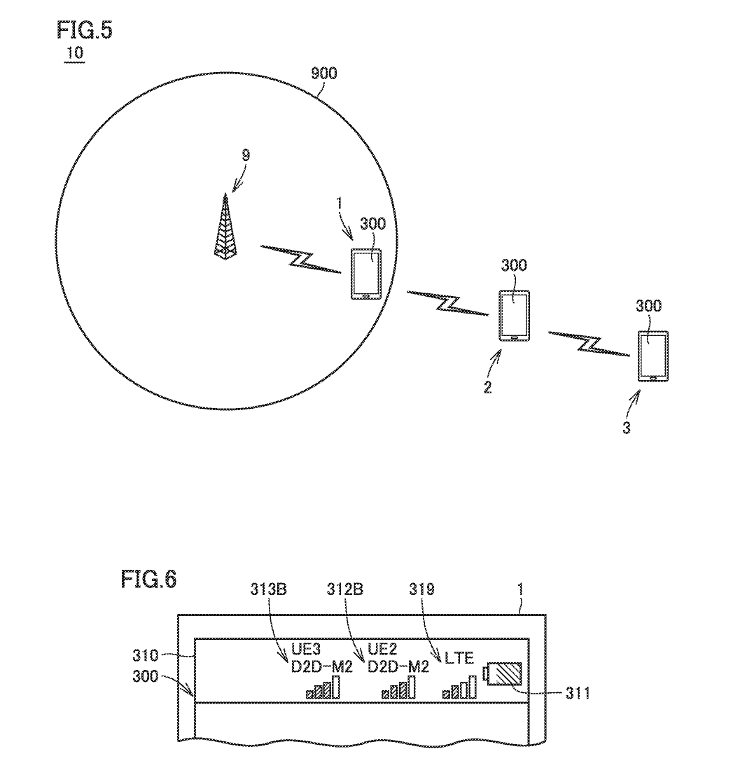

FIG. 6 is a diagram for illustrating antenna pictos on UE 1 in the conditions of FIG. 5. Referring to FIG. 6, UE 1 displays battery picto 311, LTE antenna picto 319, and D2D antenna pictos 312B and 313B on status bar 310.

D2D antenna picto 312B is based on the reception level of a radio wave transmitted by UE 2 over the D2D communications. D2D antenna picto 313B is for UE 3.

Specifically, D2D antenna picto 312B includes identification information for clarifying that this picto is for the D2D communications. Typically, UE 1 displays a string D2D near antenna bars. D2D antenna picto 312B includes identification information for clarifying that this picto is for UE 2. Typically, UE 1 displays a string “UE 2” near the antenna bars. Further, D2D antenna picto 312B includes information representing the above operating mode of UE 1. Note that D2D antenna picto 313B also includes various identification information items, as with D2D antenna picto 312B.

Specifically, UE 1 calculates the reception level of a radio wave transmitted by UE 3, utilizing the communications with UE 3 via UE 2 (hereinafter, also referred to as a “first technique”). Alternatively, UE 1 obtains from UE 2 the reception level measured by UE 2, the reception level being of the radio wave transmitted by UE 3 (hereinafter, also referred to as a “second technique”). UE 1 displays D2D antenna picto 313B, based on the calculated or obtained reception level. Note that the first technique and the second technique will be described in detail below.

As described above, UE 1 displays D2D antenna picto 313B, in addition to D2D antenna picto 312B. Thus, the user of UE 1 is allowed to know that UE 1 is communicable with UE 3 via UE 2.

<C. Third Aspect>

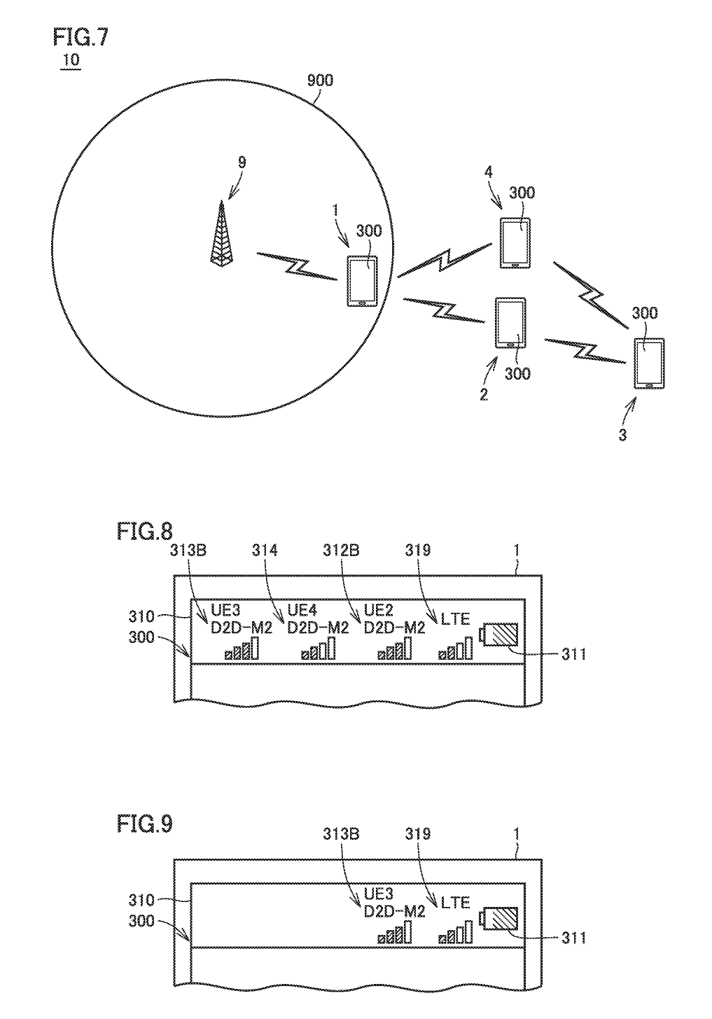

FIG. 7 is a diagram for illustrating a third aspect in the communication system 10. Referring to FIG. 7, in the third aspect, communication system 10 includes eNB 9, UE 1, UE 2, UE 3, and a UE 4.

UE 1 is within cell 900 served by eNB 9. On the other hand, UE 2, UE 3, and UE 4 are out of cell 900.

D2D communications have been established between UE 1 and UE 2. D2D communications have been established also between UE 2 and UE 3. Further, D2D communications have been established between UE 1 and UE 4. D2D communications have been established also between UE 3 and UE 4.

Specifically, UE 1 is communicable with UE 3 via UE 2. UE 1 is also communicable with UE 3 via UE 4. In other words, UE 1 uses UE 2 and UE 3 as relays for the communications with UE 3.

Here, UE 1 corresponds to the owner UE. UE 2 corresponds to the first third-party terminal with which UE 1 performs the D2D communications. UE 4 corresponds to a third third-party terminal which is different from UE 2 and with which UE 1 performs the D2D communications. UE 3 corresponds to the second third-party terminal with which UE 2 and UE 4 perform the D2D communications.

FIG. 8 is a diagram for illustrating antenna pictos on UE 1 in the conditions of FIG. 7. Referring to FIG. 8, UE 1 displays battery picto 311, LTE antenna picto 319, and D2D antenna pictos 312B, 313B, and 314 on status bar 310. In other words, UE 1 in FIG. 8 is different from UE 1 in FIG. 6 in that UE 1 in FIG. 8 displays D2D antenna picto 314.

D2D antenna picto 314 is based on a reception level of a radio wave transmitted by UE 4 over the D2D communications. D2D antenna picto 313B is for UE 3, as mentioned above. UE 1 displays D2D antenna picto 313B for UE 3 on status bar 310, based on the reception level that is calculated by the first technique or obtained by the second technique over either one of the communications where UE 1 uses UE 2 as a relay and the communications where UE 1 uses UE 4 as a relay.

As described above, UE 1 displays on status bar 310 the antenna pictos for UEs 2 and 4 that function as relays, as well as the antenna picto for UE 3 which is a third-party with which the user of UE 1 wishes to perform data communications (i.e., a UE which is described as a destination to which UE 1 is to transmit data). Thus, the user of UE 1 is also allowed to know the reception levels of the UEs functioning as the relays.

In the following, for purposes of distinction, the third-party with which the user of UE 1 wishes to perform the data communications is referred to as a “third-party UE” and the UE functioning as the relay is referred to as a “relay UE.”

Meanwhile, an increase of the number of relay UEs may result in the D2D antenna pictos not fitting within status bar 310. In such a case, the owner UE (UE 1 in FIG. 9) hides antenna pictos for relay UEs. This can prevent such an occurrence that the antenna picto of the third-party UE is not displayed on the status bar.

FIG. 9 is a diagram representing a situation where UE 1, which is the owner UE, has hidden antenna pictos for relay UEs in a certain aspect. Referring to FIG. 9, for example, as compared to FIG. 8, D2D antenna pictos 312B and 314 are hidden. This allows the user of UE 1 to visually confirm the antenna picto for UE 3 which is the third-party UE (i.e., D2D antenna picto 313B).

Meanwhile, focusing on UE 2 that relays the communications between UE 1 and UE 3 in the second aspect (See FIG. 5) and the third aspect (See FIG. 7), UE 2 may be said to include the following configurations.

UE 2, functioning as a relay, displays an antenna picto based on a reception level of a radio wave transmitted by UE 1 over D2D communications and an antenna picto based on a reception level of a radio wave transmitted by UE 3 over D2D communications on status bar 310 on display unit 300.

According to such a configuration, the user ofUE 2 is allowed to visually confirm a reception level of a radio wave in D2D communications between different UEs. Note that UE 4 yields the same advantageous effects as UE 2.

(Variation)

In FIG. 8, the third aspect has been described with reference to the configuration in which UE 1 displays D2D antenna picto 312B for UE 2 and D2D antenna picto 314 for UE 4 as antenna pictos for relay UEs. However, the present disclosure is not limited thereto.

UE 1 may display an antenna picto which shows the highest reception level among antenna pictos for relay UEs. For example, in the communication conditions similar to FIG. 8, UE 1 may display only D2D antenna picto 312B between D2D antenna pictos 312B and 314. Note that the state of status bar 310 on UE 1 in this case is the same as the state of status bar 310 illustrated in FIG. 6.

<D. Functional Configuration>

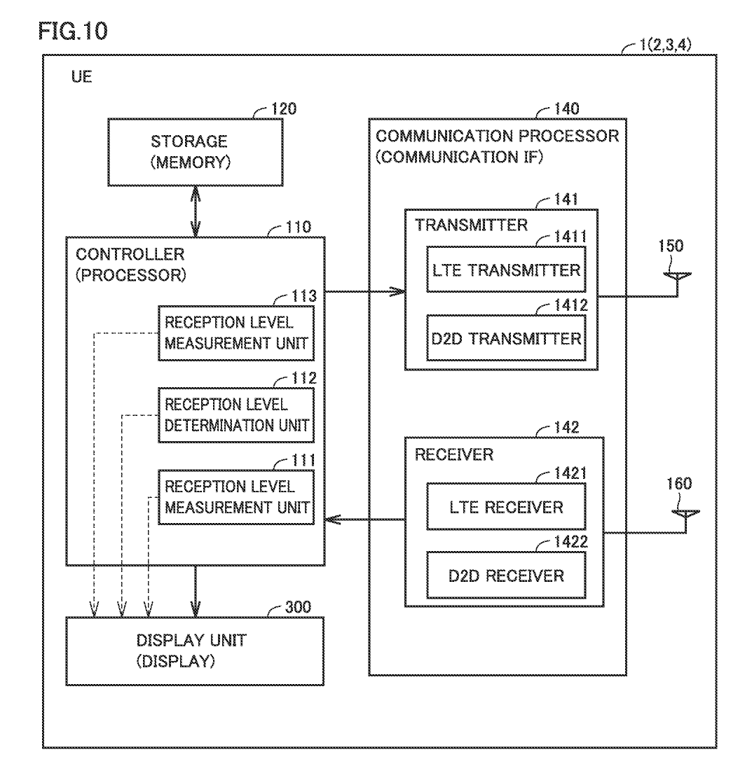

FIG. 10 is a diagram for illustrating a functional configuration of UE 1. Referring to FIG. 10, UE 1 includes a controller (such as a processor) 110, a storage 120, display unit (such as a display) 300, and a communication processor 140.

Controller 110 controls overall operation of UE 1. Storage 120 has an operating system, various application programs, and various data items stored therein. Display unit 300 displays various images (screens). Communication processor 140 performs various processing (such as RF processing, baseband processing) to communicate with eNBs such as eNB 9 and perform D2D communications with another UE, for example.

Controller 110 corresponds to a processor (typically, a central processing unit (CPU)). Specifically, controller 110 is implemented by the processor executing the operating system and the application programs stored in storage 120. Storage 120 corresponds to a memory. The memory, typically, includes read-only memory (ROM), random access memory (RAM), flash memory, etc. Display unit 300 corresponds to a display.

Communication processor 140 includes a transmitter 141 and a receiver 142. Transmitter 141 includes an LTE transmitter 1411 and a D2D transmitter 1412. Receiver 142 includes an LTE receiver 1421 and a D2D receiver 1422.

Communication processor 140 is used for the communications with eNBs and the D2D communications with other UEs. Communication processor 140 performs communications with other devices, based on a command from controller 110. Transmitter 141 transmits data to the eNBs and the other UEs. LTE transmitter 1411 transmits data to the eNBs. D2D transmitter 1412 transmits data to the other UEs over the D2D communications. Receiver 142 receives data from the eNBs and the other UEs. LTE receiver 1421 receives data from the eNBs. D2D receiver 1422 receives data from the other UEs over the D2D communications.

(Details of Controller 110)

Controller 110 includes a reception level measurement unit 111, a reception level determination unit 112, and a reception level measurement unit 113. In the following, description is given with reference, as appropriate, to the first aspect (FIG. 1), the second aspect (FIG. 5), and the third aspect (FIG. 7) described above.

(1) Reception level measurement unit 111 periodically measures a reception level of a radio wave transmitted by eNB 9. Reception level measurement unit 111 also periodically measures a reception level of a radio wave transmitted by a third-party terminal (including relays) over the D2D communications. In the first aspect and the second aspect above, reception level measurement unit 111 measures the reception level of the radio wave transmitted by eNB 9, and the reception level of the radio wave transmitted by UE 2. In the third aspect, reception level measurement unit 111 measures the reception level of the radio wave transmitted by eNB 9, and the reception levels of the radio waves transmitted by UE 2 and UE 4. In the following, the measurement process by reception level measurement unit 111 is described in detail.

Reception level measurement unit 111 included in UE 1 measures the reception level of the radio wave transmitted by the eNB by measuring a reception quality which is based on a reference signal (RS) signal (such as RSRP).

In D2D communications, UE 1 uses the band of an up link (UL) signal of another UE, such as UE 2, to communicate with the UE. Thus, reception level measurement unit 111 included in UE 1 measures the reception level in the D2D communications by measuring a reception quality that is based on the RS signal in the UL signal. Specifically, reception level measurement unit 111 measures a reception quality (such as RSRP) which is based on an RS signal transmitted by another UE. Although UE 1 uses RSRP to measure the reception quality, it should be noted that any other signal (such as RSRQ) may be used insofar as it represents the reception quality.

Meanwhile, reference signal received power (RSRP) is received power of an RS signal per resource element (15 kHz band). RS is transmitted, without being biased in frequency or in time, and is independent of traffic volume. RSRP is a value that is generally determined by fixed installation conditions of the eNB, such as transmit power of the eNB and the orientation and height of the antenna, and measurement environment such as obstructs and a distance from the eNB. Therefore, RSRP is used as a basic parameter to evaluate the reception level of a radio wave from the eNB.

(2) Reception level detennination unit 112 is a functional block for performing the first technique described above. Note that if UE 1 performs the above-described second technique instead of the first technique, UE 1 may include a reception level obtaining unit, in place of reception level determination unit 112. The reception level obtaining unit will be described below.

Reception level determination unit 112 determines (calculates) the reception level of the radio wave transmitted by UE 3, utilizing the communications with UE 3 via UE 2. Specifically, for the determination of the reception level, UE 1 performs processes (i), (ii), and (iii) which use a training signal, as follows.

(i) UE 1, which is the owner UE, embeds a training signal in down link (DL) data for UE 3 and transmits the DL data to UE 3, which is the third-party UE, via the relay UE 2, for example.

(ii) UE 3 inserts the training signal as is and transmits it in UL data. In other words, UE 3 loops the training signal back to UE 1.

(iii) Reception level determination unit 112 included in UE 1 calculates an error rate of the training signal from UE 3 and determines a reception level (reception quality), based on the calculated value. Specifically, reception level determination unit 112 calculates the error rate by comparing the training signal transmitted by UE 1 and the training signal received from UE 3 via UE 2, and determines the reception level based on the calculated value.

(3) Reception level measurement unit 113 is used when UE 1 functions as a relay UE. Unlike the first to the third aspects above, when, for example, UE 1 is in D2D communication with an owner UE (not shown), reception level measurement unit 113 measures the reception level of a radio wave sent from the owner UE.

In another aspect, when UE 1 is in communication with the owner UE via another relay UE, reception level measurement unit 113 measures the reception level of a radio wave sent from the relay UE.

In other words, reception level measurement unit 113 is different from reception level measurement unit 111 in a set of relay networks, in that reception level measurement unit 113 measures the reception level of a radio wave sent from a UE that is closer to an eNB relative to UE 1, while reception level measurement unit 111 measures the reception level of a radio wave sent from a UE farther away from an eNB relative to UE1.

(4) Controller 110 displays, on display unit 300, the antenna pictos for displaying the various reception levels described above, in accordance with a status of UE 1. Specifically, controller 110 displays the various antenna pictos illustrated in (A) of FIG. 2, FIG. 3, FIG. 4, FIG. 6, FIG. 8, and FIG. 9 on display unit 300.

Since UEs 2, 3, and 4 have configurations same as UE 1, the functional configurations of UEs 2, 3, and 4 are not described herein.

(Variation)

In the above, the present disclosure has been described with reference to the configuration in which UE 1, etc. include reception level determination unit 112. In other words, the present disclosure has been described with reference to the configuration in which UE 1, etc. perform the first technique described above. In the following, a configuration is described in which UE 1, etc. perform the second technique described above, instead of the first technique. Moreover, in the following, for purposes of explanation, the present disclosure will be described with reference to the second aspect (See FIG. 5) above.

UE 1, etc. include the reception level obtaining unit (not shown), in place of reception level determination unit 112 to carry out the second technique, as mentioned above.

UE 2, which is a relay UE, measures the reception level of the radio wave transmitted by UE 3. UE 2 further inserts the result of the measurement (the reception level) in data for UE 1 and transmits the data to UE 1.

The reception level obtaining unit included in UE 1 demodulates the data transmitted from UE 2, thereby obtaining the reception level of the third-party UE 3. In other words, the reception level obtaining unit obtains from UE 2 the reception level, measured by UE 2, of the radio wave transmitted by UE 3.

This allows UE 1 to display the antenna picto for UE 3 (D2D antenna picto 313B in FIG. 6) on status bar 310, as illustrated in FIG. 6 for example.

<E. Control Structure>

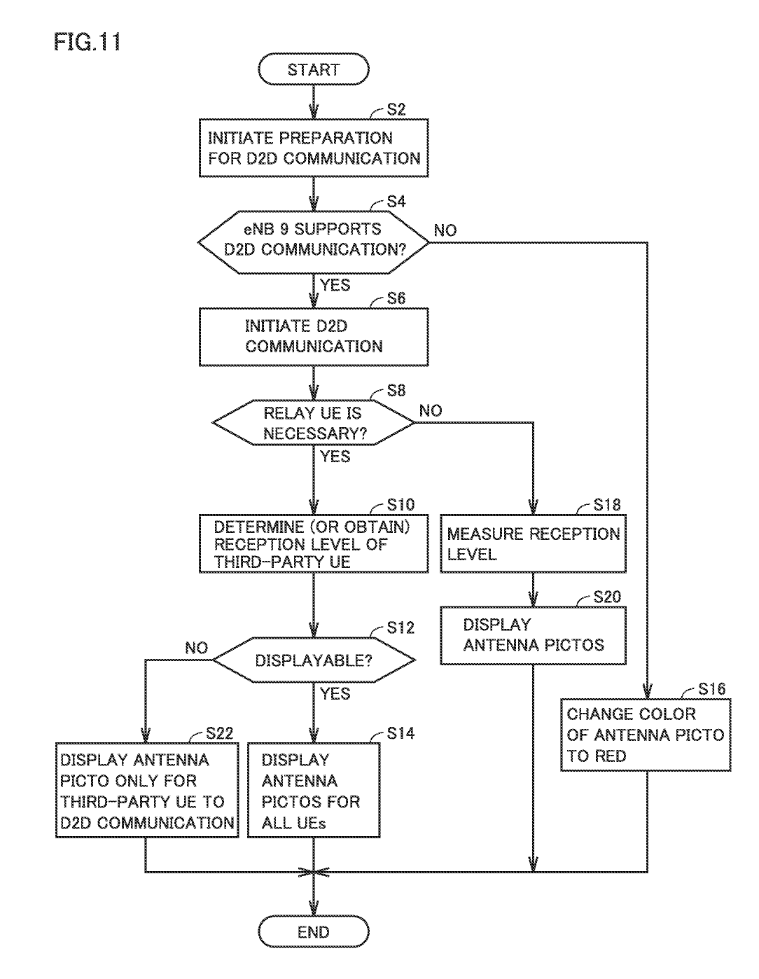

FIG. 11 is a flowchart for illustrating a flow of operation by UE 1. Referring to FIG. 11, in step S2, UE 1, which is the owner UE, initiates preparation for the D2D communications. In step S4, UE 1 determines whether cNB 9 supports the D2D communications, based on the broadcast information sent from eNB 9.

If UE 1 determines that eNB 9 supports the D2D communications (YES in step S4), UE 1 initiates the D2D communications with another UE (e.g., UE 2, UE 4) in step S6. If UE 1 determines that eNB 9 does not support the D2D communications (NO in step S4), UE 1 changes the color of LTE antenna picto 319 from blue (the first color) to red (the second color) in step S16.

In step S8, UE 1 determines whether a relay UE is necessary for the communications with the third-party UE. For example, UE 1 determines whether a relay UE is necessary, based on whether UE 1 is able to communicate with the third-party UE (UE 3 in the second aspect and the third aspect above) over the D2D communications, without via another UE.

If UE 1 determines that no relay UE is necessary (NO in step S8), UE 1, in step S18, measures the reception level of a UE (e.g., UE 2 in the first aspect above) which is the third-party with which UE 1 performs the D2D communications. In step S20, UE 1 displays an LTE antenna picto and a D2D antenna picto on status bar 310 displayed on display unit 300. In the first aspect above for example, UE 1 displays the pictos as illustrated in (A) of FIG. 2.

If UE 1 determines that the relay UE is necessary (YES in step S8), UE 1, in step S10, determines the reception level of the third-party UE, using, for example, the first technique described above. Alternatively, UE 1 obtains the reception level of the third-party UE from the relay UE, using the second technique described above.

In step S12, UE 1 determines whether all the D2D antenna pictos for the third-party UE and the relay UE can be displayed on status bar 310. If UE 1 determines that all the D2D antenna pictos for the third-party UE and the relay UE can be displayed on status bar 310 (YES in step S12), UE 1, in step S14, displays the antenna pictos for all the UEs on status bar 310, as illustrated in FIG. 8 for example. If UE 1 determines that all the D2D antenna pictos for the third-party UE and the relay UE cannot be displayed on status bar 310 (NO in step S12), UE 1, in step S16, displays the antenna picto for only the third-party UE for the D2D communications, among the D2D antenna pictos, as illustrated in FIG. 9 for example.

Since UEs 2, 3, and 4 perform processes same as the process illustrated in FIG. 11 when they each function as the owner UE, it should be noted that the flow of operation when UEs 2, 3, and 4 each function as the owner UE is not described herein.

The embodiment presently disclosed is illustrative and not limited to only the description set forth above. The scope of the present invention is defined by the appended claims, and all changes which come within the meaning and range of equivalency of the appended claims are intended to be included within the scope of the present disclosure.

### REFERENCE SIGNS LIST

1, 2, 3, 4 UE; 9 eNB; 10 communication system; 110 controller, 111, 113 reception level measurement unit; 112 reception level determination unit; 120 storage; 140 communication processor; 141 transmitter, 142 receiver; 300 display unit; 310 status bar; 311 battery picto; 312, 312A, 312B, 313B, 313C, 314 D2D antenna picto; 319 LTE antenna picto; 900 cell; 1411, 1412 LTE transmitter; 1421, 1422 D2D receiver

1. A mobile terminal capable of a device-to-device communication, the mobile terminal comprising:
a controller; and
a display unit,
the controller being configured to cause the display unit to display a first antenna pictogram based on a reception level of a radio wave transmitted by a base station, and a second antenna pictogram based on a reception level of a radio wave transmitted by a first third-party terminal over the device-to-device communication.

2. The mobile terminal according to claim 1, wherein
when the first third-party terminal is within a cell served by the base station, the mobile terminal operates in a first operating mode as an operating mode in which the mobile terminal performs the device-to-device communication, wherein, in the first operating mode, the mobile terminal uses a radio resource assigned by the base station to communicate with the first third-party terminal,
when the first third-party terminal is out of the cell served by the base station, the mobile terminal operates in a second operating mode as the operating mode, wherein, in the second operating mode, the mobile terminal uses a radio resource assigned by the mobile terminal to communicate with the first third-party terminal, and
the controller causes the display unit to display information representing that the operating mode is one of the first operating mode and the second operating mode.

3. The mobile terminal according to claim 1, wherein
the mobile terminal communicates with a second third-party terminal via the first third-party terminal, the second third-party terminal being configured to perform the device-to-device communication with the first third-party terminal, and
the controller:
determines a reception level of a radio wave transmitted by the second third-party terminal, using communication with the second third-party terminal via the first third-party terminal, or obtains from the first third-party terminal the reception level, measured by the first third-party terminal, of the radio wave transmitted by the second third-party terminal; and
causes the display unit to display a third antenna pictogram based on the reception level determined or obtained.

4. The mobile terminal according to claim 3, wherein
the mobile terminal is communicable with the second third-party terminal via a third third-party terminal, without via the first third-party terminal, the third third-party terminal being configured to perform the device-to-device communication with the second third-party terminal, and
the controller further causes the display unit to display a fourth antenna pictogram based on a reception level of a radio wave transmitted by the third third-party terminal over the device-to-device communication.

5. A mobile terminal capable of a device-to-device communication, the mobile terminal comprising:
a controller; and
a display unit,
the controller being configured to cause the display unit to display a first antenna pictogram based on a reception level of a radio wave transmitted by a first third-party terminal over the device-to-device communication, and a second antenna pictogram based on a reception level of a radio wave transmitted by a second third-party terminal over the device-to-device communication,
the mobile terminal being configured to relay communication between the first third-party terminal and the second third-party terminal.
